(19) United States
(12) Patent Application Publication
(10) Pub. No.: US 2008/0134855 A1
(43) Pub. Date: Jun. 12, 2008

(54) Frame Saw

(76) Inventor: Reinhold Mayr, Waldzell (AT)

Correspondence Address: COLLARD & ROE, P.C., 1077 NORTHERN BOULEVARD, ROSLYN, NY, 11576, US

(21) Appl. No.: 11/919,319

(22) PCT Filed: May 2, 2006
(86) PCT No.: PCT/AT2006/000179

§ 371 Date: Jan. 30, 2008

(30) Foreign Application Priority Data
Apr. 29, 2005 (AT) A 1043/2005

(51) Int. Cl. B26D 1/06

(52) U.S. Cl. 83/425.3

(57) ABSTRACT

A frame saw is described, comprising a reciprocating saw frame (3) which is guided via guide means (9, 15) along lateral guide rails (4) and which comprises a sash (5) with two stringers (6, 7) for clamping parallel saw-blades (8) which cut in only one lifting direction, and a slider-crank drive (2) which is connected with the reciprocating saw frame (3) via lateral pushrods (12) in the area of the stringer (6) closest to the same. In order to provide advantageous constructional conditions it is proposed that the two pushrods (12) of the slider-crank drive (2) act upon a common crossbeam (10) for receiving the sash (5) in the area of the two stringer (6, 7) which is closest to the slider-crank drive (2), that the crossbeam (10) rests with the help of guide means (15) on the lateral guide rails (4), and that the crossbeam (10) is held in a swivelable manner relative to its guide means (15) about an axle (16) perpendicular to the guide rails (4) and the crossbeam (10).

### 1. FIELD OF THE INVENTION

The invention relates to a frame saw, comprising a reciprocating saw frame which is guided via guide means along lateral guide rails and which comprises a sash with two stringers for clamping parallel saw-blades which cut in only one lifting direction, and a slider-crank drive which is connected with the reciprocating saw frame via lateral pushrods in the area of the stringer closest to the same.

### 2. DESCRIPTION OF THE PRIOR ART

In the case of frame saws with saw-blades clamped in a sash, the reciprocating saw frame which is usually driven via a slider-crank drive is held with the help of slide blocks in lateral guide rails of a frame, with the possibility being provided to link the pushrods of the slider-crank drive to the sash in the area of the stringer closer or remoter relative to the slider-crank drive, between which the saw-blades are clamped. The connection of the pushrods with the closer of said stringers not only provides better accessibility to the reciprocating saw frame, but also leads to positive load conditions for the sash when the cutting stroke occurs in the direction of the closer stringer because in this case the long-beams of the sash connecting the stringers would be loaded in a tensile manner during the cutting stroke. Despite these constructional preconditions for a comparatively light design, the achievable stroke frequency remains limited. With the increase in the stroke frequency, the inertial forces and thus the loads on the guide means increase disproportionally.

### SUMMARY OF THE INVENTION

The invention is based on the object of arranging a frame saw of the kind mentioned above in such a way that a noticeable increase in the stroke frequency of the reciprocating saw frame can be achieved without needing to fear an overload of the guide means of the reciprocating saw frame. Moreover, it should be possible to carry out a change of the sash with a low amount of reconfiguration work.

This object is achieved by the invention in such a way that the two pushrods of the slider-crank drive act upon a common crossbeam for receiving the sash in the area of the stringer which is closest to the slider-crank drive, that the crossbeam rests with the help of guide means on the lateral guide rails and that the crossbeam is held in a swivelable manner relative to its guide means about an axle perpendicular to the guide rails and the crossbeam.

Since as a result of these measures the introduction of forces from the slider-crank drive to the sash occurs by way of a crossbeam connecting the two lateral pushrods of the slider-crank drive with each other, which crossbeam is held on the lateral guide rails with the help of guide means and is held in a swivelable manner relative to said guide means about an axle perpendicular to the guide rails and the crossbeam, said guide means can be relieved from torque loads that would inevitably occur otherwise. In the area of the stringer which is remoter from the slider-crank drive, these torques caused by the attack of the pushrods do not occur, so that the sash in the region of the remoter stringer can be held directly without any linked connection via respective guide means on the guide rails.

In order to improve the cutting speed on the one hand and the cutting precision on the other hand, the guide means for the crossbeam and the basic frame can be arranged in the area of the stringer which is remoter from the slider-crank drive as recirculating ball bearing guides which enable a substantially play-free displacement guidance of the reciprocating saw frame, which also leads to an extension of the service life of the saw-blades.

The crossbeam which is held on the lateral guide rails and is connected to the slider-crank drive not only allows for favorable introduction of force into the sash, but also offers simple changing conditions for the reciprocating saw frame because it is not necessary to detach the drive connection between the crossbeam and the slider-crank drive for removing the sash. Favorable constructional conditions are obtained in this connection when the crossbeam is inserted into a receiving groove of the stringer closer to the slider-crank drive, because in this case the sash merely needs to be lifted from the receiving groove after the detachment of its connection with the guide means in the area of the sturdy beam remoter from the slider-crank drive. The play-free receiving of the crossbeam in the receiving groove of the stringer can advantageously be achieved in such a way that the receiving groove of the stringer comprises groove walls converging towards the base of the groove, on which rests the crossbeam with respectively inclined opposite surfaces as soon as the cross-beam is pulled against the base of the receiving groove with the help of fastening screws for example.

### BRIEF DESCRIPTION OF THE DRAWINGS

The subject matter of the invention is shown by way of example in the drawings, wherein:

FIG. 1 shows a frame saw in accordance with the invention in sections in a schematic cross-sectional view in the area of the slider-crank drive, and

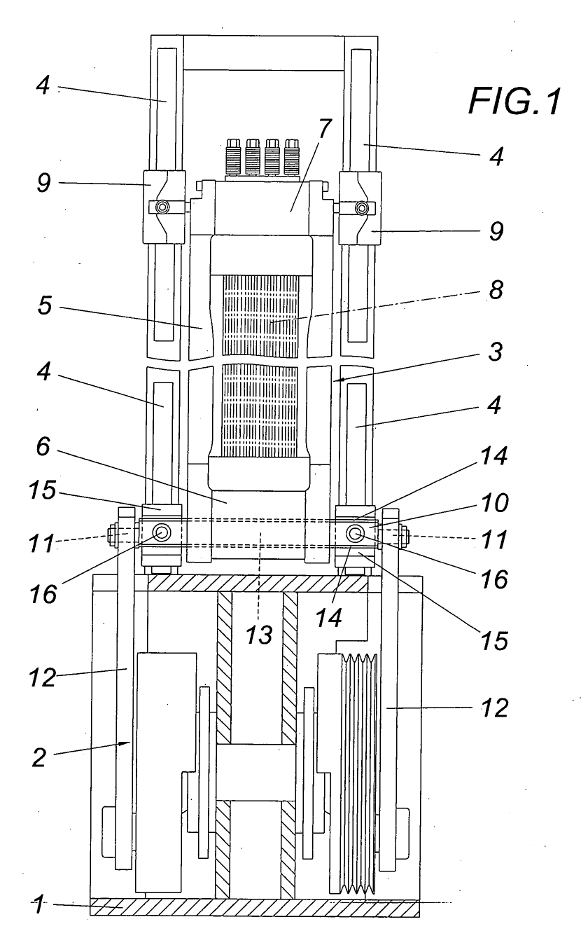

FIG. 2 shows said frame saw in a partly profile, simplified side view.

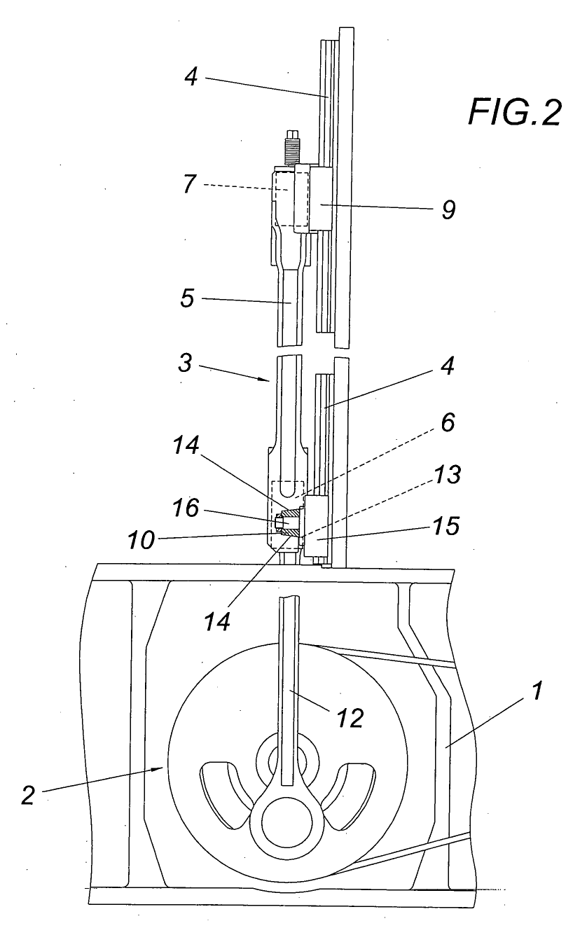

### DESCRIPTION OF THE PREFERRED EMBODIMENT

The illustrated frame saw comprises a frame 1, in which a slider-crank drive 2 for driving a reciprocating frame saw 3 is held. The reciprocating frame saw 3 which is displaceable along its lateral guide rails 4 comprises a sash 5 with two stringers 6, 7 which are connected with each other with long-beams and between which the saw-blades 8 are clamped. Whereas the sash 5 is detachably connected directly with the guide means 9 for the lateral guide rails 4 in the area of the stringer 7 which is remoter to the slider-crank drive 2, the sash 5 rests in the region of the opposite stringer 6 closer to the slider-crank drive 2 on a crossbeam 10 which carries axially protruding link pins 11 for lateral pushrods 12 of the slider-crank drive 2. The crossbeam 10 is held in a receiving groove 13 of the stringer 6. Since the groove walls of the receiving groove 13 converge towards the base of the groove and the crossbeam 10 forms respectively inclined opposite surfaces 14, the crossbeam 10 engages in a play-free manner into the receiving groove 13 when the crossbeam 10 is pulled with the help of fastening screws against the base of the groove.

The crossbeam 10 is guided over guide means 15 along the lateral guide rails 4, so that a respective displaceability of the sash 5 is obtained along the lateral guide rails 4 also in the region of the stringer 6 closer to the slider-crank drive 2. The connection between the crossbeam 10 and the guide means 15 is not rigid in order to avoid torque loads of the guide means 15 during bending of the crossbeam 14. For this reason, the fastening of the crossbeam 10 on the guide means 15 occurs via axles 16 which extend perpendicular to the respective guide rail 4 and the crossbeam 10. With such a linkage of the crossbeam 10 to the associated guide means 15, the sliding guide for the sash 5 remains substantially free from constraining forces which might have a disadvantageous effect on the precision of the guidance, so that advantageous preconditions are fulfilled by this construction for an increase in the stroke frequency of the reciprocating frame saw 3, since a lightweight configuration is obtained without impairing the reciprocating frame saw 3. In order to release the sash 5, it is merely necessary to detach the connections of the sash 5 with the guide means 9 on the one hand and with the crossbeam 10 on the other hand, which can be performed quickly with little effort.

Although the guide means 9, 15 for the sash 5 in the region of the stringer 7 remoter from the slider-crank drive on the one hand and the crossbeam 10 on other hand can also be arranged as sliding guides, more advantageous conditions can be achieved concerning the guidance precision of the sash 5 by the use of recirculating ball bearing guides, which has an advantageous effect on the cutting precision, the achievable cutting speed and also on the service life of the saw-blades.

1. A frame saw, comprising a reciprocating saw frame which is guided via guide means along lateral guide rails and which comprises a sash with two stringers for clamping parallel saw-blades which cut in only one lifting direction, and a slider-crank drive which is connected with the reciprocating saw frame via lateral pushrods in the area of the stringer closest to the same, wherein the two pushrods (12) of the slider-crank drive (2) act upon a common crossbeam (10) for receiving the sash (5) in the area of the two stringer (6, 7) which is closest to the slider-crank drive (2), that the crossbeam (10) rests with the help of guide means (15) on the lateral guide rails (4), and that the crossbeam (10)is held in a swivelable manner relative to its guide means (15) about an axle (16) perpendicular to the guide rails (4) and the crossbeam (10).

2. A frame saw according to claim 1, wherein the guide means (9, 15) for the crossbeam (10) and the sash (5) are arranged in the area of the stringer (7) which is remoter from the slider-crank drive (2) as recirculating ball bearing guides.

3. A frame saw according to claim 1, wherein the crossbeam (10) is inserted into a receiving groove (13) of the stringer (6) which is closer to the slider-crank drive (2).

4. A frame saw according to claim 3, wherein the receiving groove (13) of the stringer (6) comprises groove walls which converge towards the groove base.
